(19) United States
(12) Patent Application Publication
(10) Pub. No.: US 2015/0236954 A1
(43) Pub. Date: Aug. 20, 2015

(54) Mobile Node Mapping Information Update Triggering Method, MS and MN

(71) Applicant: ZTE CORPORATION, Shenzhen , Guangdong (CN)

(72) Inventors: Li Cheng, Shenzhen (CN); Mo Sun, Shenzhen (CN)

(73) Assignee: ZTE CORPORATION, Shenzhen City, Guangdong Province (CN)

(21) Appl. No.: 14/434,521

(22) PCT Filed: Dec. 5, 2012
(86) PCT No.: PCT/CN2012/085897

§ 371 Date: Apr. 9, 2015

(30) Foreign Application Priority Data
Dec. 9, 2011 (CN) 201110409503.0

(51) Int. Cl. H04L 12/747; H04L 12/801; H04L 12/56

(52) U.S. Cl. CPC H04L 45/742; H04L 45/741; H04L 47/12

(57) ABSTRACT

A mobile node mapping information update triggering method, information reporting method, mapping server and mobile node, applied to a Locator/Identifier Separation Protocol (LISP) network, wherein the mobile node mapping information update triggering method comprises: a mapping server (MS) receiving a mapping registration message for updating mapping information transmitted by a MN attached to the MS; the MS acquiring the information of a communication peer, and according to the information of the communication peer, transmitting a mapping update message to a peer mapping cache device corresponding to the communication peer of the MN, thus triggering the peer mapping cache device to update the cached mapping information. In the abovementioned solution, it overcomes the problem that the mobile node has to bear a large amount of signaling overheads in order to update the peer cache.

### TECHNICAL FIELD

The present document relates to the field of mobile communication and the Internet, and more particularly, to a mobile node mapping information update triggering method, an information reporting method, a mapping server, and a mobile node.

### BACKGROUND OF THE INVENTION

In order to solve the problem of continuous routing table expansion, to better meet the user demands on technologies such as mobility support, multi-homing network deployment, and traffic engineering deployment, the design of identifier/locator separation network architecture becomes the current hotspot in the industry.

The Locator/ID Separation Protocol (LISP) technology is a relatively popular solution based on host identifier and host locator separation, as shown in FIG. 1, it is the basic logic structure of the existing LISP network, and its implementation is as follows:

the site network (usually refer to the user network) and the transport network (usually the operator network) are separated, the address space is divided into Endpoint Identifier (EID, representing the address within the site network) address space and Routing Locator (RLOC, representing the accessibility in said border router network) address space. The routing information within the site network in the network, that is, the EID address information, is not published in the transport network, and two site networks are connected by establishing a tunnel across the transport network between the Ingress Tunnel Router (ITR) and the Egress Tunnel Router (ETR). The site network achieves the maintenance of the EID to RLOC mapping information through a independent mapping system.

As shown in FIG. 1, the LISP network architecture comprises a data plane and a mapping plane.

The data plane forwards and transmits the packets. As shown in FIG. 1, the source node for generating data packets in the LISP site sends the packets to the ITR of its site network. The ITR performs LISP-encapsulation on the packets according to the mapping relationship of the destination node EID address cached or obtained from the mapping plane to the RLOC address of the ETR of the site where the destination node is located, and then sends the encapsulated packets to the ETR of the destination site. After the ETR removes the outer LISP encapsulation of the packets, it forwards said data packets to the destination node within the site based on destination EID address of the data packets.

The mapping plane can help the ITR to find out the site ETR corresponding to the destination node and obtain the mapping information. The LISP mapping plane shown in FIG. 1 consists of the mapping plane forwarding network (there are a variety of mapping plane forwarding network architectures, such as the alternative logical topology (ALT) network, Delegated Database Tree (DDT), and so on), the mapping resolver (MR) and the mapping server (MS). The ETR registers the EID to RLOC mapping information within the site into the MS. When the ITR in the LISP site needs to search for the destination node mapping information, the ITR sends a mapping request message to the MR, and takes the EID address of the destination node as the destination address of the request message. The MR forwards the request message to the MS maintaining the destination EID address information through the mapping plane forwarding network, so as to further search out the corresponding site ETR. After the ITR caches the mapping information responded by the MS or the destination site ETR, it encapsulates and forwards said packet.

It is worthy of noting that, in order to achieve the intercommunication of the LISP network and the traditional network, the LISP architecture also introduces the proxy ITR (PITR) and the proxy ETR (PETR), and they can be seen as the ITR and ETR corresponding to the traditional network communication node in the packet forwarding process.

As shown in FIG. 2, in the LISP architecture, in order to implement the mobility support, each LISP mobile node (Mobile Node, MN) is taken as a LISP site, and the LISP MN can perform some functions of the ETR and the ITR. One LISP MN device comprises two IDs: endpoint identifier (EID), MN's EID address usually does not change; routing locator (RLOC), when the LISP MN moves to a new location, it can dynamically obtain the RLOC address. At present, the mapping plane forwarding network architecture usually requires the LISP MN to anchor the mapping registration on the corresponding MS. After the MN acquires the new RLOC address, it immediately sends the mapping register message to the corresponding MS and updates the mapping information.

In addition to the MS corresponding to the LISP MN, the MN's peer mapping cache device (comprise the ITR device corresponding to the communication peer node, the PITR device corresponding to the communication peer node and the LISP MN of the communication peer) also caches the mapping information of said LISP MN. Some methods for the LISP MN updating the mapping information in the peer mapping cache device are proposed in the prior art, for example, after the location switches, the LISP MN sends a mapping request triggering message to the peer currently in communication before the switch; sets a very short effective time for the mapping information in the mapping response message, so that the communication peer can avoid not timely mapping update by frequent mapping requests for search; according to the version number of the destination mapping information in the received data packet, judge whether it needs to trigger the peer to update the mapping information or not; maintain the PITR cache, and store the information of all the PITR devices searching for the mapping information.

According to the abovementioned method, the mobile node can update the mapping cache of the communicate peer. However, since one mobile node can communicate with multiple communication peer devices simultaneously, and then correspond to multiple peer mapping cache devices. Based on the methods in the prior art, the mobile node updates the cache in the peer, which brings a huge amount of signaling overheads to the mobile node and increases the burden on the mobile node.

### SUMMARY

The embodiment of the present document provides a mobile node mapping information update triggering method, an information reporting method, a mapping server, and a mobile node, to overcome the problem that the mobile node have to bear a lot of signaling overheads for updating the peer cache.

The embodiment of the present document provides a mobile node (MN) mapping information update triggering method, applied to a locator/identifier separation protocol (LISP) network, and said method comprises:

a mapping server (MS) receiving a mapping registration message sent by a MN attached to said MS for updating mapping information;

said MS acquiring information of a communication peer, and according to the information of said communication peer, sending a mapping update message to a peer mapping cache device corresponding to said MN's communication peer node to trigger said peer mapping cache device to update cached mapping information.

Preferably, said communication peer comprises said peer mapping cache device;

the information of said communication peer comprises locator information of said peer mapping cache device.

Preferably, before said MS receives said mapping registration message sent by said MN attached to said MS for updating said mapping information, said method further comprises:

said MS receiving said communication peer's information reported by said MN;

said MS establishing and maintaining a communication peer table storing the information of said communication peer;

said MS acquiring the information of said communication peer, comprises:

said MS obtaining the information of said communication peer from said communication peer table.

Preferably, said MS acquiring the information of said communication peer comprises:

said MS acquiring the information of said communication peer from said mapping registration message.

Preferably, said MS maintaining said communication peer table storing the information of said communication peer comprises:

said MS presetting a time value for each entry in said communication peer table and deleting said entry when living time of the entry exceeds said time value; wherein, said time value is larger than a time interval of reporting the information of said communication peer.

Preferably, said MS maintaining said communication peer table storing the information of said communication peer further comprises:

said MS comparing received information of a current communication peer with the entries in said communication peer table, if there is no duplicate entry, establishing a new entry in said communication peer table, and writing the information of said current communication peer into said new entry; if there is a duplicate entry, resetting said time value to an initial value.

Preferably, said MS maintaining said communication peer table storing the information of said communication peer further comprises:

said MS finding out that said MN is offline or shuts down, then deleting the mapping information registered by said MN, and also deleting said communication peer table maintained for said MN.

The embodiment of the present document provides an information report method, applied to a Locator/Identifier Separation Protocol (LISP) network, and said method comprises:

a mobile node (MN), after receiving a data packet transmitted by a communication peer node of said MN, extracting information of said communication peer from said data packet; said MN reporting the information of said communication peer to a mapping server (MS) corresponding to said MN.

Preferably, said communication peer comprises a peer mapping cache device corresponding to said communication peer node of said MN; the information of said communication peer comprises a locator information of said peer mapping cache device.

Preferably, after said MN extracts the information of said communication peer from said data packet, said method further comprises: said MN comparing the information of said communication peer with the entries in said established peer information table, and if said entries do not have the information of said communication peer, then creating a new entry in said peer information table, and adding the information of said communication peer into said new entry.

Preferably, said MN reporting the information of said communication peer to said MS comprises:

said MN regularly reporting the information of said communication peer to said MS; or

after said mapping information changes, said MN reporting the information of said communication peer to said MS.

Preferably, said MN reporting the information of said communication peer to said MS comprises:

said MN reporting the information of said communication peer to said MS in real time.

Preferably, said method further comprises: said MN setting a predetermined time interval for said entries in said peer information table, and if said data packet sent by said MN's communication end node corresponding to the current entry is not received within said predetermined time interval, deleting said current entry.

The embodiment of the present document further provides a mapping server (MS), applied to a Locator/Identifier Separation Protocol (LISP) network, and said MS comprises:

a receiving module, set to: receive a mapping registration message sent by a MN attached to said MS for updating a mapping information;

an update triggering module, set to: acquire information of a communication peer, send a mapping update message to a peer mapping cache device corresponding to said MN's communication peer node according to the information of said communication peer, and trigger said peer mapping cache device to update the cached mapping information.

Preferably, said communication peer comprises said peer mapping cache device;

the information of said communication peer comprises a locator information of said peer mapping cache device.

Preferably, said MS further comprises an establishing and maintaining module;

said receiving module is further set to: receive said communication peer's information reported by said MN;

said establishing and maintaining module is set to: establish and maintain a communication peer table storing the information of said communication peer;

said update triggering module is set to: acquire information of said communication peer from said communication peer table.

Preferably, said update triggering module is set to: receive the information of said communication peer from said mapping registration message.

Preferably, said establishing and maintaining module is set to: preset a time value for each entry in said communication peer table, and when living time of the entry exceeds said time value, delete said entry; wherein, said time value being larger than a time interval of reporting the information of said communication peer.

Preferably, said establishing and maintaining module is further set to: compare the received information of the current communication peer with the entries in said communication peer table, if there is no a duplicate entry, create a new entry in said communication peer table, and write the information of said current communication peer into said new entry; if there is a duplicate entry, reset said time value to the initial value.

Preferably, said establishing and maintaining module is further set to: when finding that said MN is offline or shuts down, delete the mapping information registered by said MN, and also delete said communication peer table maintained for said MN.

The embodiment of the present document further provides a mobile node (MN), applied to a Locator/Identifier Separation Protocol (LISP) network, and said MN comprises:

an extracting module, set to: after receiving a data packet transmitted by a communication peer node of said MN, extract the information of said communication peer from said data packet;

a reporting module, set to: report the information of said communication peer to a mapping server (MS) corresponding to said MN.

Preferably, said communication peer comprises a peer mapping cache device corresponding to the communication peer node of said MN; the information of said communication peer comprises a locator information of said peer mapping cache device.

Preferably, said reporting module is set to: real-time or regularly report the information of said communication peer to said MS; or, after said mapping information changes, report the information of said communication peer to said MS.

In the abovementioned mobile node mapping information update triggering method, when said mobile node mapping information changes, the mapping server corresponding to said mobile node initiates an update of the mapping information of said peer mapping cache device, to overcome the problem that said mobile node have to bear a large number of signaling overheads for updating the peer cache.

### BRIEF DESCRIPTION OF THE DRAWINGS

FIG. 1 is a network architecture diagram of a first conventional LISP embodiment;

FIG. 2 is a network architecture diagram of a second conventional LISP embodiment;

FIG. 3 is a signaling flow chart of a first embodiment of a method for updating the mapping information of a MN in accordance with the present document;

FIG. 4 is a signaling flow chart of a second embodiment of a method for updating the mapping information of a MN in accordance with the present document;

FIG. 5 is a signaling flow chart of a third embodiment of a method for updating the mapping information of a MN in accordance with the present document;

FIG. 6 is a structural diagram of a MS embodiment in accordance with the present document;

FIG. 7 is a structural diagram of a MN embodiment in accordance with the present document.

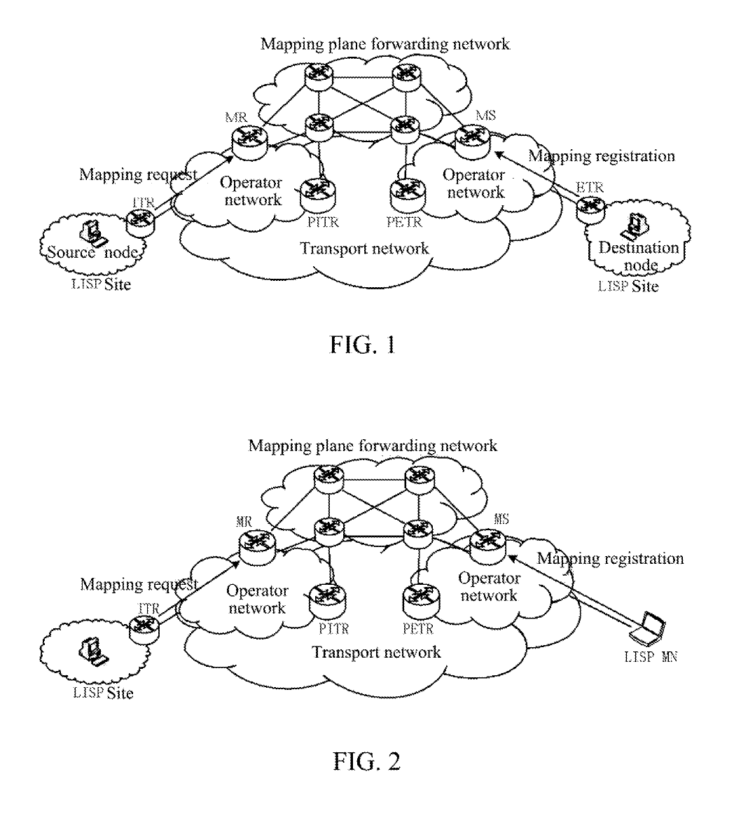

### PREFERRED EMBODIMENTS OF THE PRESENT INVENTION

Hereinafter, with combination of the accompanying figures, the embodiment of the present document will be described in detail. It should be noted that, in the case of no conflict, the embodiments and the features in the embodiments of the present application may be arbitrarily combined with each other.

In order to more clearly describe the contents of the embodiments of the present document, part of the technical terms used in the embodiments of the present document will be described as follows:

communication peer node: a node communicating with said LISP MN. Said node can be located in said LISP network or a traditional network; it may be a mobile node, or a static node whose location usually does not change.

Peer mapping cache device: a device which LISP encapsulate and forwards data packets sent by said communication peer node to said LISP MN, and is possible to cache said LISP MN mapping information. Such a device comprises an ITR device or a PITR device corresponding to said communication peer node.

It is worth noting that, if the communication peer node of said LISP MN is also a LISP MN, said peer LISP MN acts as both a communication peer node and a peer mapping cache device.

The embodiment of the present document provides a method for triggering an update of mapping information of a mobile node (MN), applied to a Locator/Identifier Separation Protocol (LISP) network, and this embodiment is described in the perspective of a MS, and said method comprises:

step 11, said mapping server (MS) receives a mapping registration message sent by said MN attached to said MS for updating said mapping information;

before said MS receives said mapping registration message sent by said MN attached to said MS, said method further comprises:

said MS receiving said communication peer's information reported by said MN;

said MS establishing and maintaining a communication peer table storing the information of said communication peer.

Step 12, said MS acquires the information of said communication peer, and sends a mapping update message to the peer mapping cache device corresponding to the communication end node of said MN according to the information of said communication peer, and triggers said peer mapping cache device to update the cached mapping information.

Wherein, said communication peer may comprise said peer mapping cache device; may further comprise a communication peer node; the information of said communication peer can be a locator information of said communicate peer.

Said MS acquiring the information of said communication peer comprises: said MS acquiring the information of said communication peer from said communication peer table, or acquiring the information of said communication peer from said mapping registration message.

The embodiment of the present document provides an information reporting method, applied to a Locator/Identifier Separation Protocol (LISP) network, and this embodiment is described from the perspective of a MN, and said method comprises:

step 21, after receiving a data packet transmitted by the communication peer node of said MN, said mobile node (MN) extracts the information of said communication peer from said data packet.

Wherein, said communication peer comprises the peer mapping cache advice corresponding to the communication peer node of said MN; the information of said communication peer comprises the locator information of said peer mapping cache device.

Step 22, said MN reports the information of said communication peer to the mapping server (MS) corresponding to said MN.

Said MN reporting the information of said communication peer to said MS comprising:

said MN regularly or real-time reporting the information of said communication peer to said MS; or

after the mapping information changes, said MN reporting the information of said communication peer to said MS.

In the following, the technical solution in accordance with the embodiment of the present document will be described from the perspective that the MS, the MN, the communication peer node and the peer mapping cache device are interacting with each other:

### The First Embodiment

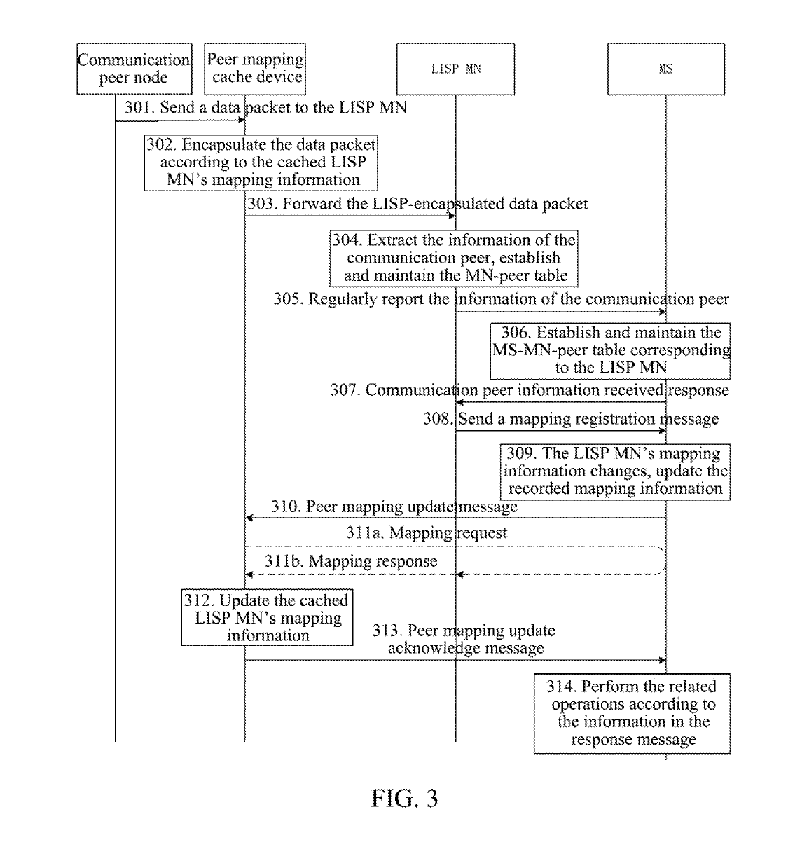

As shown in FIG. 3, it is a signaling flow chart of the first embodiment of the method for updating the MN's mapping information in accordance with the present document, and this embodiment is applicable to the case that said LISP MN regularly reports the related information of the communication peer to the corresponding MS, and updates the LISP MN's MS-MN-peer table maintained by said MS. As shown in FIG. 3, it specifically comprises the following steps:

step 301, the communication peer node of said LISP MN sends a data packet to said LISP MN, the destination address and the source address of said packet correspond to the identifiers of said LISP MN and said communication peer node, and said data packet is forwarded to the peer mapping cache device corresponding to said communication peer node;

step 302, based on said LISP MN's mapping information cached in the local or cached after being acquired through searching via said mapping plane, said peer mapping cache device performs LISP encapsulation on said data packet;

the destination address and the source address of said data packet correspond to the respective locators of said LISP MN and said peer mapping cache device;

step 303, said peer mapping cache device sends said packet through the tunnel to said LISP MN;

steps 301-303 are the prior art.

Step 304, after said LISP MN receives said LISP encapsulated packet, it extracts the related information of said communication peer from said data packet.

Said LISP MN can store the information of multiple communication peers, and then form a peer information table, which is called MN-peer table, established and maintained by said LISP MN; said communication peer comprises at least the peer mapping cache device, and may further comprises a communications peer node.

Furthermore, after said LISP MN extracts the relevant information, said LISP MN compares the extracted information with the entries in said MN-peer table. If said MN-peer table does not have the extracted information, said MN creates a new entry in the table and adds said information into said new entry.

It is worth noting that the main purpose for said LISP MN establishing said peer information table in accordance with the present document is to timely update the mapping information in said peer mapping cache device, so said MN-peer table can only record the locator information of said peer mapping cache device.

Preferably, said LISP MN can choose to record the relevant information of both said communicate peer node and said peer mapping cache device simultaneously according to the actual needs.

Step 305, said LISP MN regularly reports the information in said MN-peer table to the corresponding MS.

Based on the prior art, said LISP MN periodically sends the mapping registration message to said MS. In this embodiment, it can choose to attach the information in said MN-peer table to said LISP MN's mapping registration message to report.

Optionally, said LISP MN may also use another message to report the relevant information of said communication peer, only if the abovementioned information report function can be achieved.

Step 306, said MS establishes and maintains one communication peer table, known as MS-MN-peer table, for each registered LISP MN, and said MS can search out the corresponding MS-MN-peer table based on said LISP MN's identifier.

After said MS receives the peer's information reported by said LISP MN, it fills the reported peer's information in the MS-MN-peer table corresponding to side LISP MN.

It is worthy of noting that in this embodiment, said MS may manage the MS-MN-peer table based on aging mechanism. In this case, said MS should set a time value for each entry in the peer table, and the preset time value of said entry corresponds to the survival time of said entry. When the entry is newly created, or a duplicate entry is received (update), said value is set to an initial value. After that, if the duplicate entry of said entry has never been received, and the survival time of said entry exceeds said preset value, it considers that said entry is aging and then deletes the entry. Said time value should be greater than the time interval for said LISP MN reporting the information of said communicate peer.

Furthermore, there may be entries in the peer's information reported by said LISP MN duplicating with entries in said MS-MN-peer table currently maintained by said MS, thus before said MS fills said reported information into said MS-MN-peer table, it needs to compare whether there is a duplicate entry or not. If there is a duplicate entry, then it resets the effective time of said entry in said MS-MN-peer table to the initial value; if there is no duplicate entry, then creates a new entry in said MS-MN-peer table and fills in the newly reported information.

Furthermore, if said MS finds out that the LISP MN attached to this MS is offline or shuts down, said MS deletes the mapping information registered by said LISP MN and deletes the MS-MN-peer table maintained by said LISP MN.

Step 307, said MS returns a communication peer information received response message to said LISP MN.

In the prior art, after said MS receives the mapping registration message sent by said LISP MN, it returns a notification message to confirm. In the present embodiment, said message can be extended to be used as the communicate peer information received response.

Optionally, another message can also be used as the response message, as long as the abovementioned response function can be achieved.

Step 308, after the LISP MN's mapping information changes, the LISP MN immediately sends a mapping registration message to said MS.

Step 309, after said MS receives said LISP MN's new mapping information, said MS updates the locally recorded mapping information.

Step 310, said MS sends a peer mapping update message to the peer mapping cache device according to the information in said locally maintained MS-MN-peer table corresponding to said LISP MN, and said message carries said LISP MN's new mapping information.

Steps 311a and 311b are optional, after said peer mapping cache device receives said MS' mapping update message, said peer mapping cache device selects to initiate a mapping request message to said mapping plane to obtain said LISP MN's mapping information so as to ensure that said information is correct.

Step 312, said peer mapping cache device updates the cached LISP MN's mapping information.

It is worthy of noting that if currently there is no said LISP MN's mapping information in said peer mapping cache device, after receiving said mapping update message sent by said MS, said peer mapping cache device may choose not adding said mapping information into said cache, but search again when it needs to forward data packet.

Step 313, said peer mapping cache device responds a peer mapping update acknowledge message to said MS.

It is worthy of noting that if said peer mapping cache device currently does not buffer said LISP MN's mapping information, and does not add said LISP MN's mapping information after receiving said update message, then when responding said update acknowledge message, it can choose to indicate said MS that currently it is not said LISP MN's peer mapping cache device and require said MS to remove the corresponding entry in said MS-MN-peer table.

Step 314, said MS perform related operations, such as deleting some peer information entries in said MS-MN-peer table, based on the contents of the received mapping update acknowledge message.

### The Second Embodiment

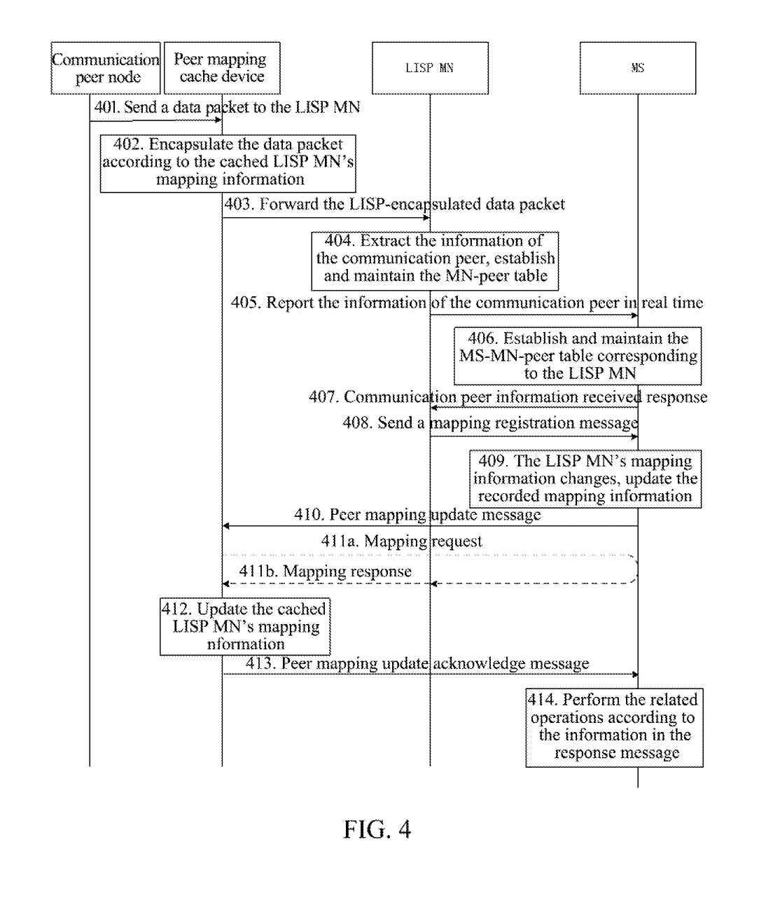

As shown in FIG. 4, it is a signaling flow chart of the second embodiment of the method for updating the MN's mapping information in accordance with the present document, and the present embodiment is applicable to the case that said LISP MN real-time updates the relevant information of said communication peer on the corresponding MS. As shown in FIG. 4, it comprises the following steps:

steps 401-403, the same as the steps 301-303;

step 404, after said LISP MN receives said LISP encapsulated packet, said LISP MN extracts the relevant information of said communication peer from said data packet;

said LISP MN can store the information of a plurality of communication peers, and then form a peer information table, called MN-peer table, established and maintained by said LISP MN;

furthermore, after said LISP MN extracts the relevant information, it compares the extracted information with the entries in said MN-peer table. If the extracted information is not in said table entries, said MN creates a new entry in the table and adds said information into it.

Furthermore, in this embodiment, the entries in said MN-peer table locally maintained by said LISP MN can be set a predetermined time interval, if no data packet sent by said MN's communication peer node corresponding to said entry is received within said predetermined time interval, the corresponding entry in said peer table can be deleted.

Step 405, when it needs to add an entry or delete an entry from said MN-peer table maintained by said LISP MN, said LISP MN reports information about said added or deleted entry to the corresponding MS, and indicates operations on said entry;

step 406, said MS establishes and maintains a communication peer table, known as the MS-MN-peer table, for each registered LISP MN, said MS can search out the corresponding MS-MN-peer table based on said LISP MN's identifier;

after said MS receives the information reported by said LISP MN, according to the operation in the reported message, adds an entry in or deletes an entry from said MS-MN-peer table;

furthermore, if said MS finds out that the LISP MN attached to the MS is offline or shuts down, said MS deletes the mapping information registered by said LISP MN and deletes the MS-MN-peer table maintained for said LISP MN.

Steps 407-414 are the same as steps 307-314.

### The Third Embodiment

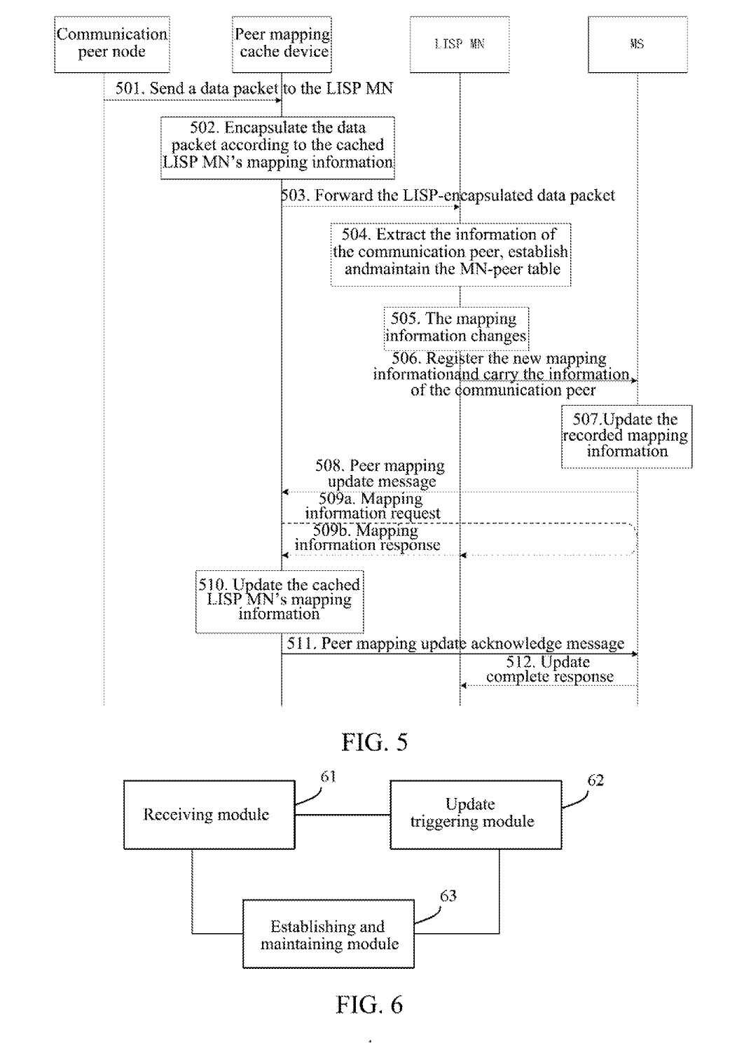

As shown in FIG. 5, it is a signaling flow chart of the third embodiment of the method for updating the mapping information of the MN in accordance with the present document, the present embodiment is applicable to the case that when said LISP MN mapping information changes, it reports the relevant information of the communication peer node to the corresponding MS. As shown in FIG. 5, it specifically comprises the following steps:

steps 501-504 are the same as steps 301-304;

step 505, said LISP MN's mapping information changes; typically said LISP MN's locator changes, for example, said LISP MN's location switches, and it acquires a new locator;

step 506, said LISP MN sends a mapping registration message to the corresponding MS to update said mapping information. Said LISP MN can carry the communication peer's information in said MN-peer table into said message;

alternatively, when said LISP MN's mapping information changes, another message may also be used to report the information of the communication peer, so as to achieve said information report function.

Step 507, after said MS receives said LISP MN's mapping registration message, it updates the locally stored mapping information;

step 508, said MS sends a mapping update message to the communication peer of said LISP MN according to the acquired relevant information of said communication peer, and carries said LISP MN's new mapping information into said message;

steps 509-511 are the same as the steps 311-313;

step 512, after said MS receives the update responses of all the communication peers, the MS sends an update complete response to said LISP MN.

Based on the abovementioned method, said mobile node reports the information of said peer mapping cache device to the corresponding mapping server, and said mapping server manages the information of the communication peers of said mobile node, and when the mapping information registered by said mobile node changes, promptly notifies said peer mapping cache device to update the cached mapping information, thus reducing the large amount of signaling overheads that have to be taken by said mobile node to notify said peer, and reducing the burden on said mobile node.

FIG. 6 is a structural diagram of a MS embodiment of the present document, and said MS comprises receiving module 61 and update triggering module 62, wherein:

said receiving module is used to receive the mapping registration message sent by said MN attached to said MS for updating said mapping information;

said update triggering module is used to acquire the information of said communication peer, and send a mapping update message to the peer mapping cache device corresponding to said MN's communication peer node based on the information of said communication peer, and trigger said peer mapping cache device to update the cached mapping information.

Wherein, said communication peer may comprise said peer mapping cache device; the information of said communication peer can comprise the locator information of said peer mapping cache device; of course, said communication peer may also comprise a communication peer node.

Furthermore, said MS further comprises establishing and maintaining module 63, wherein: said receiving module is further used to receive said communication peer's information reported by said MN; said establishing and maintaining module is used to establish and maintain the communication peer table storing the information of said communication peer; said update triggering module is used to acquire the information of said communication peer from said communication peer table; said MS update triggering process can refer to FIG. 3 and FIG. 4. Said update triggering module is used to obtain the information of said communication peer from said mapping registration message, and said MS update triggering process can refer to FIG. 5.

In particular, said establishing and maintaining module is used to preset a time value for each entry in said communication peer table, when the living time of said entry exceeds said time value, delete said entry; wherein, said time value is greater than the time interval of reporting the information of said communication peer.

Additionally, said establishing and maintaining module is further used to compare the received information of said current communication peer with the entries in said communication peer table, if there is no duplicate entry, create a new entry in said communication peer table, and write the information of said current communication peer into said new entry; if there is a duplicate entry, then reset said time value to the initial value.

Furthermore, said establishing and maintaining module is also used to, when finding out that said MN is offline or shuts down, delete the mapping information registered by said MN, and also delete said communication peer table maintained for said MN.

When the mapping information registered by said MN changes, said MS promptly notifies said peer mapping cache device to update the cached mapping information, thus reducing a lot of signaling overheads that said mobile node needs to take for notifying the peer and reducing the burden on said mobile node.

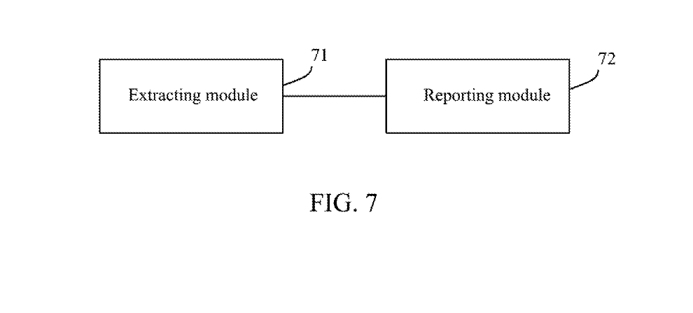

FIG. 7 is a structural diagram of a MN embodiment of the present document, and said MN comprises extracting module 71 and reporting module 72, wherein: said extracting module is used to, after receiving a data packet sent by the communication peer node of said MN, extract the information of said communication peer from said data packet; said reporting module is used to report the information of said communication peer to the mapping server (MS) corresponding to said MN.

Wherein, said communication peer comprises the peer mapping cache device corresponding to the communication peer node of said MN; the information of said communication peer comprises the locator information of said peer mapping cache device.

In particular, said reporting module is used to regularly or real-time report the information of said communication peer to said MS; alternatively, after said mapping information changes, report the information of said communication peer to said MS.

The abovementioned MN reports the information of the communication peer to the corresponding mapping server, thus allowing said MS timely notifies said peer mapping cache device to update the cached mapping information when the mapping information registered by said MN changes, thus reducing a large number of signaling overhead that said mobile node has to undertake for notifying the peer and reducing the burden on said mobile node.

Those ordinarily skilled in the art can understand that all or some of steps of the abovementioned method may be completed by the programs instructing the relevant hardware, and said programs may be stored in a computer-readable storage medium, such as read only memory, magnetic or optical disk. Optionally, all or some of the steps of the abovementioned embodiments may also be implemented by using one or more integrated circuits. Accordingly, each module/unit in the abovementioned embodiments may be realized in the form of hardware or software function module. The present document is not limited to any specific form of hardware and software combinations.

The above embodiments are only used to illustrate but not intended to limit the technical scheme of the present document, and they only illustrate the present document in detail with reference to the preferred embodiments. A person skilled in the art should understand that the technical scheme of the present document may have various modifications and equivalent replacements which, if without departing from the spirit and principle of the technical scheme of the present document, should be included within the claims of the present document.

### INDUSTRIAL APPLICABILITY

In the abovementioned mobile node mapping information update triggering method, when said mobile node mapping information changes, the mapping server corresponding to said mobile node initiates an update of the mapping information of said peer mapping cache device, to well overcome the problem that said mobile node have to bear a large number of signaling overheads for updating the peer cache.

What is claimed is:

1. A mobile node (MN) mapping information update triggering method, applied to a locator/identifier separation protocol (LISP) network, wherein, said method comprising:
a mapping server (MS) receiving a mapping registration message sent by a MN attached to said MS for updating mapping information;
said MS acquiring information of a communication peer, and according to the information of said communication peer, sending a mapping update message to a peer mapping cache device corresponding to said MN's communication peer node to trigger said peer mapping cache device to update cached mapping information.

2. The method of claim 1, wherein,
said communication peer comprises said peer mapping cache device;
the information of said communication peer comprises locator information of said peer mapping cache device.

3. The method of claim 2, wherein,
before said MS receives said mapping registration message sent by said MN attached to said MS for updating said mapping information, said method further comprises:
said MS receiving said communication peer's information reported by said MN;
said MS establishing and maintaining a communication peer table storing the information of said communication peer;
said MS acquiring the information of said communication peer, comprises:
said MS obtaining the information of said communication peer from said communication peer table.

4. The method of claim 2, wherein,
said MS acquiring the information of said communication peer comprises:
said MS acquiring the information of said communication peer from said mapping registration message.

5. The method of claim 3, wherein,
said MS maintaining said communication peer table storing the information of said communication peer comprises:
said MS presetting a time value for each entry in said communication peer table and deleting said entry when living time of the entry exceeds said time value; wherein, said time value is larger than a time interval of reporting the information of said communication peer:
preferably, wherein,
said MS maintaining said communication peer table storing the information of said communication peer further comprises:
said MS finding out that said MN is offline or shuts down, then deleting the mapping information registered by said MN, and also deleting said communication peer table maintained for said MN.

6. The method of claim 5, wherein,
said MS maintaining said communication peer table storing the information of said communication peer further comprises:
said MS comparing received information of a current communication peer with the entries in said communication peer table, if there is no duplicate entry, establishing a new entry in said communication peer table, and writing the information of said current communication peer into said new entry; if there is a duplicate entry, resetting said time value to an initial value.

7. (canceled)

8. An information report method, applied to a Locator/Identifier Separation Protocol (LISP) network, wherein, said method comprises:
a mobile node (MN), after receiving a data packet transmitted by a communication peer node of said MN, extracting information of said communication peer from said data packet;
said MN reporting the information of said communication peer to a mapping server (MS) corresponding to said MN.

9. The method of claim 8, wherein,
said communication peer comprises a peer mapping cache device corresponding to said communication peer node of said MN;
the information of said communication peer comprises a locator information of said peer mapping cache device.

10. The method of claim 8, wherein,
after said MN extracts the information of said communication peer from said data packet, said method further comprises:
said MN comparing the information of said communication peer with entries in said established peer information table, and if said entries do not have the information of said communication peer, creating a new entry in said peer information table, and adding the information of said communication peer into said new entry.

11. The method of claim 10, wherein,
said MN reporting the information of said communication peer to said MS comprises:
said MN regularly reporting the information of said communication peer to said MS; or
after said mapping information changes, said MN reporting the information of said communication peer to said MS.

12. The method of claim 10, wherein,
said MN reporting the information of said communication peer to said MS comprises:
said MN reporting the information of said communication peer to said MS in real time;
preferably, said method further comprises:
said MN setting a predetermined time interval for said entries in said peer information table, and if said data packet sent by said MN's communication end node corresponding to the current entry is not received within said predetermined time interval, deleting said current entry.

13. (canceled)

14. A mapping server (MS), applied to a Locator/Identifier Separation Protocol (LISP) network, wherein, said MS comprising:
a receiving module, set to: receive a mapping registration message sent by a MN attached to said MS for updating a mapping information;
an update triggering module, set to: acquire information of a communication peer, send a mapping update message to a peer mapping cache device corresponding to said MN's communication peer node according to the information of said communication peer, and trigger said peer mapping cache device to update the cached mapping information.

15. The MS of claim 14, wherein,
said communication peer comprises said peer mapping cache device;
the information of said communication peer comprises a locator information of said peer mapping cache device.

16. The MS of claim 15, wherein, said MS further comprises an establishing and maintaining module;
said receiving module being further set to: receive said communication peer's information reported by said MN;
said establishing and maintaining module being set to: establish and maintain a communication peer table storing the information of said communication peer;
said update triggering module being set to: acquire information of said communication peer from said communication peer table.

17. The MS of claim 15, wherein,
said update triggering module is set to: receive the information of said communication peer from said mapping registration message.

18. The MS of claim 16, wherein,
said establishing and maintaining module is set to: preset a time value for each entry in said communication peer table, and when living time of the entry exceeds said time value, delete said entry; wherein, said time value being larger than a time interval of reporting the information of said communication peer;
preferably, said establishing and maintaining module is further set to: when finding out that said MN is offline or shuts down, delete the mapping information registered by said MN, and also delete said communication peer table maintained for said MN.

19. The MS of claim 18, wherein,
said establishing and maintaining module is further set to: compare the received information of the current communication peer with the entries in said communication peer table, if there is no a duplicate entry, create a new entry in said communication peer table, and write the information of said current communication peer into said new entry; if there is a duplicate entry, reset said time value to an initial value.

20. (canceled)

21. A mobile node (MN), applied to a Locator/Identifier Separation Protocol (LISP) network, wherein, said MN comprises:
an extracting module, set to: after receiving a data packet transmitted by a communication peer node of said MN, extract information of said communication peer from said data packet;
a reporting module, set to: report the information of said communication peer to a mapping server (MS) corresponding to said MN.

22. The MN of claim 21, wherein,
said communication peer comprises a peer mapping cache device corresponding to the communication peer node of said MN;
the information of said communication peer comprises a locator information of said peer mapping cache device.

23. The MN of claim 21, wherein,
said reporting module is set to: real-time or regularly report the information of said communication peer to said MS; or, after said mapping information changes, report the information of said communication peer to said MS.
